(19) United States
(12) Patent Application Publication
(10) Pub. No.: US 2011/0208718 A1
(43) Pub. Date: Aug. 25, 2011

(54) METHOD AND SYSTEM FOR ADDING ANCHOR IDENTIFIERS TO SEARCH RESULTS

(75) Inventor: Paul Tarjan, San Jose, CA (US)

(73) Assignee: Yahoo!, Inc., a Delaware corporation, Sunnnyvale, CA (US)

(21) Appl. No.: 12/710,865

(22) Filed: Feb. 23, 2010

(51) Int. Cl. G06F 17/30; G06F 3/00

(52) U.S. Cl. 707/711; 715/762; 707/E17.108

(57) ABSTRACT

Methods and systems are provided that may be utilized to determine one or more selectable anchor identifiers for one or more search results.

### BACKGROUND

1. Field

The subject matter disclosed herein relates to a method and system for determining one or more selectable anchor identifiers for one or more search results.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

There is a wide variety of web documents available on the World Wide Web. Some of these web documents may contain information of interest such as, text or other descriptions relating to a certain topic. Such web documents can be presented in a variety of different formats. Some web documents may contain content relevant to a particular search query at different locations within such web documents.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating certain processes associated with an exemplary computing environment having an Information Integration System according to one implementation;

FIG. 2 illustrates an example of search results according to one or more implementations;

FIG. 3 illustrates a web document according to one or more implementations;

FIG. 4 illustrates a process for providing selectable links to locations in a web document according to one or more implementations; and

FIG. 5 is a schematic diagram illustrating a computing environment system that may include one or more devices configurable to perform a search using one or more techniques illustrated above, for example, according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web.” The web may be considered an Internet service organizing information through the use of hypermedia. Here, for example, the HyperText Markup Language (HTML) may be used to specify the contents and format of a web document (e.g., a web page).

Unless specifically stated, a “web document,” as used herein, may refer to either the source code, data, and/or a file accessible or identifiable in a search. A web document may comprise an HTML web page, an Extensible Markup Language (XML) document, or a media file, to name a few among many possible examples of web documents. A web document may, for example, include embedded references to images, audio, video, other web documents, etc., just to name a few examples. One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocols.

Through the use of the web, users may have access to millions of pages of information. However, because there is so little organization to the web, at times it may be extremely difficult for users to locate the particular web documents that contain the information that may be of interest to them. To address this problem, a mechanism known as a “search engine” may be employed to index a large number of web documents and provide an interface that may be used to search the indexed information, for example, by entering certain words or phrases to be queried.

A search engine may, for example, comprise part of an information integration system that may also include a “crawler” or other process that may “crawl” the Internet in some manner to locate web documents. Upon locating a web document, such a crawler may store the web document's URL, and possibly follow hyperlinks associated with the web document, for example to locate other web documents.

An information integration system may also include an information extraction engine or other like process adapted to extract and/or otherwise index certain information about the web documents that were located by the crawler. Such index information may, for example, be generated based on the contents of an HTML file associated with a web document and may be included in a stored index, for example within a database.

A search engine may allow users to search the database, for example, via a user interface that allows a user to input or otherwise specify search query terms (e.g., keywords or other like criteria) and receive and view search results. A search engine may, for example, present search result summaries in a particular order as may be indicated by a ranking function or other like process. A search result summary may, for example, include information about a web document such as a title, an abstract, a link, and/or possibly one or more other related objects to assist a user in deciding whether to access the web document.

Should a user decide to access a web document based on the search result summary, the user may, through a user interface, indicate such desire by initiating access to the web document. For example, a user may select a link or other like selectable mechanism within a search result summary to initiate access to the web document through a browser or other like process that may be used to access and render web documents on a display device. A user may select a link by using a mouse, touch screen, track ball, or any other type of device capable of receiving a user input for selecting an item.

Some implementations of a search engine may analyze a particular web document to determine relevant items for characterizing such as a web document. Relevant items may include, for example, key words utilized within a title, a URL, or within a body of a web document containing text. “Key words,” as used herein, may refer to a single word or multiple words in a phrase, for example, contained within a web document that may indicate a subject matter of a web document. For example, the phrase “car sales” within a web document may be a key word that may indicate that the subject matter of the web document is related to car sales. A search engine may store such relevant items in a searchable index.

A search engine may also determine one or more abstracts or summaries for a web document. For example, an abstract may include one or more sentences or phrases that characterize a web document. In one or more implementations, one or more abstracts may be determined for a particular web document. If, for example, a web document is relatively long or contains many paragraphs of text, several different abstracts may be determined for such a web document. Different abstracts may be determined based upon different keywords. For example, a web document relating to baseball may contain a paragraph in which pitcher Randy Johnson is mentioned. If “Randy Johnson” is a key word string, one or more sentences or groupings of words from such a web document may be utilized as an abstract for the web document. Multiple different abstracts may be determined for a web document based upon different search terms. For example, search string “Nolan Ryan” may be associated with a different abstract than would search string “Randy Johnson.”

According to one or more implementations, a user may be provided with access to a search engine. In one example, a user may access the Yahoo!™ search engine at Yahoo.com and may enter a search query into a search query box. Upon receiving a query from a user, a database may parse the query and determine web documents relevant to the query. For example, a search engine may determine a list of web documents containing key words or other information, such as images or other media, relevant to a search query. A search engine may determine a relevance score for web documents relative to a search query and may rank web documents based on the relevance score.

A search engine may also select an abstract for a web document that is most closely related to a search query based on, for example, a relevance score between different abstracts and the search query. A search engine may return a list of search results relevant to a particular search query entered into a search engine box or form by a user, for example. In one or more implementations, a number of search results may be returned for a search query. If there are more than a predefined number of relevant search results, such as ten search results, then search results may be displayed via graphical user interface in increments of ten search results per page, for example. Search results may be presented in order of decreasing relevance, based at least in part upon a predefined relevance score determined for a web document relative to a search query. Search results in a list may include a title of a web document, a abstract of such a web document, and a link, such as a URL, to a location where such a web document is stored on a network, such as the Internet.

In one or more implementations, a title or a URL for a particular web document on a list of results may be selectable. For example, a user may select a title or URL via use of a user input device such as a computer mouse, stylus, track ball, keyboard, or any other device capable of receiving an input from a user. However, a displayed abstract for a web document may not be selectable in some implementations. In the event that a user selects a web document on a list of search results, a user's web browser, for example, may retrieve the web document from a location where it is stored on a network such as the Internet. If a web document is relatively long such as, for example, a web document that contains too much media or text to be displayed on a user's display screen at a single time, a user may scroll through such a web document to view content other than a portion initially displayed in a browser window to a user. In one or more implementations, if a search engine only provides a link to a web document itself, only the top portion of a web document may initially be displayed in a user's viewable browser window. Accordingly, if a web document is long, a user may spend time scrolling through a web document or searching for relevant terms within the web document. Such a process may be cumbersome to a user.

One or more implementations as discussed herein may provide a user-friendly process for presenting a list of search results to a user. In one implementation, a user may submit a search query and a search engine may determine a list of relevant web documents pertaining to such a search query. A search engine may also determine relevant abstracts to present based on a search query. Such abstracts may be selectable by a user via a graphical user interface. For example, a user may select an abstract for a search result by using a mouse or other user input device. An abstract may include a link to a portion of a web document relating to the abstract. A web document indexer may determine various anchor tags within a web document.

An “anchor” tag, as used herein, may refer to a tag specifying a location in a web document. For example, an anchor tag may indicate the start of a heading, paragraph, or section within a web document. A web document may include different tags supplied by a programmer. For example, some web documents may include one or more different identifier (ID) tags to specify a node, such as a heading, within such web documents. In one particular example, an ID tag may be utilized to designate a title within a web document. Such an ID tag may be inserted into a web document by a programmer to specify a style or format of a web document. For example, a web document may include several ID tags and a programmer may add code to specify that ID tags having a particular name or value are to be presented in a particular way. In one or more implementations, an ID tag may specify a font size, color, or background color, or other information. There are other types of tags which may be included within a web document, such as a “Name” tag. A Name tag may be utilized to identify a particular form on a web document requesting a username or password, for example.

Instead of merely providing a link to a web document that only shows the start of such a web document, a link to a portion of a web document relevant to an abstract may be provided in response to a user selecting an abstract in a list of search results. For example, if a web document has a URL, www.baseballtestdocument.com, and contains several different paragraphs or sections, different abstracts may be determined for different search queries. To provide a user with a user-friendly way of viewing a relevant portion of a web document, a link may be provided to such a relevant portion of the web document. A web document may contain different anchor tags. Such anchor tags may be designated by use of a hash mark followed by name of an anchor tag. For example, an anchor tag relating to Randy Johnson may be listed as “#Randy_Johnson”. A selectable link for an abstract may include a link to “www.baseballtestdocument.com#Randy_Johnson” to link to a portion of an web document relating to Randy Johnson. For example, if a user selects link “www.baseballtestdocument.com#Randy_Johnson”, a portion of the web document relating to Randy Johnson may be displayed at a top of a user's web browser so that a user does not need to scroll through or otherwise search through a web document to locate such a section.

Links to different sections of a web document may be determined based at least in part on various anchor tags that have previously been programmed into such a web document. For example, as discussed above, a web document may include several different IDs. An indexer may determine a particular anchor tag for a web document based at least in part of different locations where such IDs have been placed within the web document. For a particular abstract, an anchor tag may be utilized that is closest to a location within a web document from which such an abstract was derived. For example, if an abstract includes two sentences from within the middle of a paragraph, an anchor tag may specify the start of such a paragraph. Accordingly, by selecting such an abstract, the start of such a paragraph may be displayed at the top of a user's web browser so that such a user may readily see or observe a location of a web document from such an abstract was taken or otherwise determined. In other words, if a user were to select such an abstract, a web document may be displayed on a user's web browser advanced to a portion associated with a location of a web document from such an abstract was taken or otherwise determined. “Advanced,” as used herein may refer to forwarding a displayed portion of a web document to a location associated with one or more anchor tags.

An indexer may determine whether information for an abstract was taken from a location sufficiently close to an anchor tag. In one example, if an anchor tag is so far away that it could not be simultaneously displayed with a section from which an abstract was taken, then it may not be helpful to provide a link to such an anchor tag may not be relevant to such a search term. In an example, an abstract may instead provide a link to a start or top portion of such a web document. In one example an anchor tag may be required to be within distance from information comprising the abstract. For example, an anchor tag may need to be located within less than 400 words or 1000 characters of information forming the abstract. If an anchor tag is within such a distance, a link to the anchor tag may be provided in an abstract. On the other hand, if the distance is greater than a threshold amount, a link to the start or beginning of such a web document may instead be provided within an abstract.

Recent years have witnessed prosperous growth in Web search. People are relying more on the web to obtain necessary information. Search engines act as a bridge to connect information needs of people to the information available on the web. Web search is difficult due to its dynamic nature—both web documents and search queries are changing rapidly. One issue for web search is how to represent web documents to better serve user information needs.

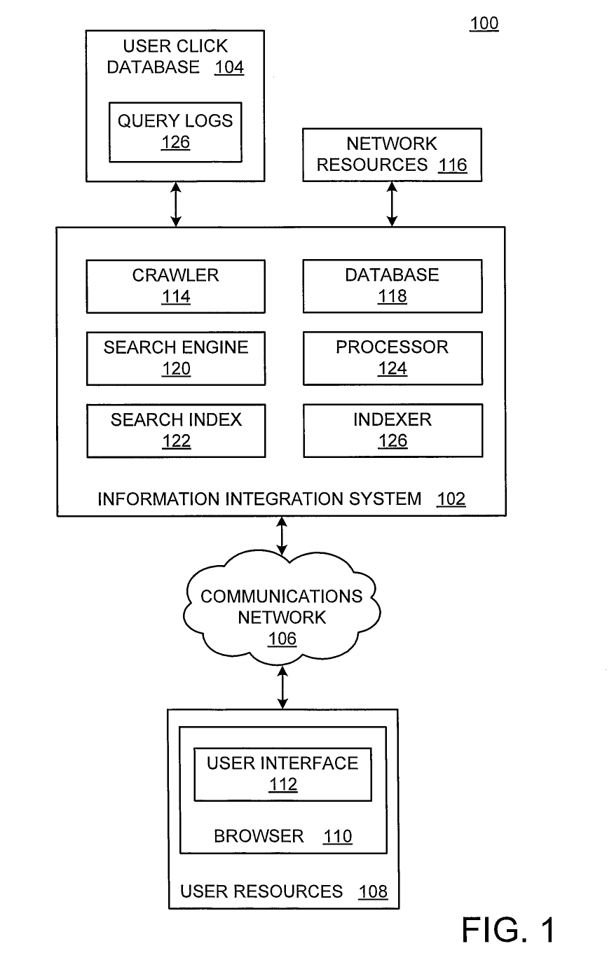

FIG. 1 is a block diagram illustrating certain processes associated with an exemplary computing environment 100 having an Information Integration System (IIS) 102 according to one implementation. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

As illustrated in FIG. 1, IIS 102 may be operatively coupled to a communications network 106. An end user may communicate with IIS 102 via communications network 106. For example, an end user may desire to search for web documents related to a certain topic of interest. Such a user may access a search engine website and submit a search query. A user may utilize user resources 108. User resources 108 may comprise a computer, a personal digital assistant (PDA), or a cellular phone with access to the Internet, to name just a few among many examples. User resources 108 may permit a browser 110 to be executed. Browser 110 may be utilized to view and/or otherwise access web documents on the Internet. User resources 108 may also include a user interface 112. User interface 112 may include, for example, a computer monitor and/or various user input devices, such as a microphone, a computer mouse, a keyboard, pointing device, touch screen, and output devices such as a display and speakers, to name just a few among many types of user input devices and output devices.

A user may access a website for a search engine and may submit a search query. A search query may be transmitted from user resources 108 to IIS 102 via communications network 106. IIS 102 may determine a list of web documents tailored based on relevance and may transmit such a list back to user resources 108 for display, for example, on user interface 112.

IIS 102 may include a crawler 114 to access network resources 116, which may include, for example, the Internet and the World Wide Web (WWW), one or more servers, etc. IIS 102 may include a database 118, a search engine 120 backed, for example, by a search index 122. IIS 102 may further include a processor 124 and/or controller to implement various modules, for example.

Crawler 114 may be adapted to locate web documents such as, for example, web documents associated with websites, etc. In one particular implementation, crawler 114 may implement a “Mozilla™-based crawl” in which, for example, fetching is performed based on a Mozilla Foundation™ source code or a modification of Mozilla Foundation™ source code. Crawler 114 may also follow one or more hyperlinks associated with a web document to locate other web documents. Upon locating a web document, crawler 114 may, for example, store the web document's URL and/or other information in database 118. Crawler 114 may, for example, store all or part of a web document (e.g., HTML, XML, object, and/or the like) and/or a URL or other like link information in database 118.

An indexer 126 may analyze one or more web documents to determine relevant key words or other information associated with the one or more web documents. For example, indexer 126 may categorize a web document or otherwise determine one or more topics of such a web document. Based on an analysis, indexer 126 may determine whether a web document contains spam in some implementations. Indexer 126 may also determine one or more different abstracts or summaries for a web document to provide in a list of search results in response to a search query.

If a user transmits a search query via user interface 112, such a search query may be received by search engine 120. Search engine 120 may determine or otherwise access a list of ranked web documents pertaining to a search query. Search engine 120 may also determine which selectable abstracts, if any, to provide in search results to allow a user to advance to a section of a web document most relevant to a particular search query. Search engine 120 may utilize an index compiled or determined by indexer 126.

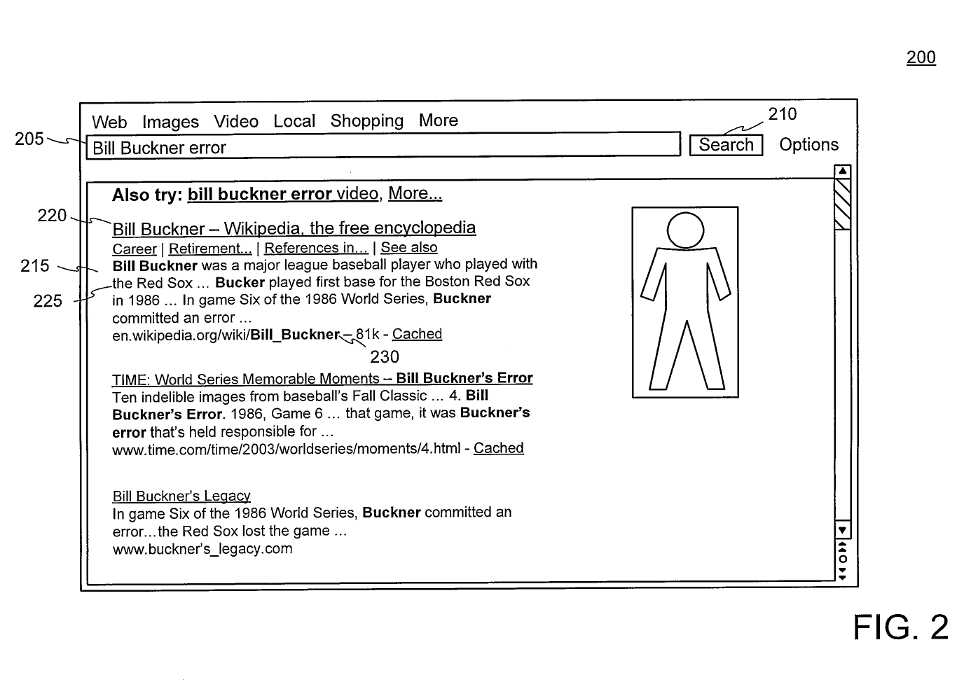

FIG. 2 illustrates an example of search results 200 according to one or more implementations. As shown, a user has submitted user query “Bill Buckner error” into a search query box 205. A user may type such a search query into search query box 205 and then select a “search” button 210. Such a search query may be received by a search engine which may determine a list of one or more web documents relevant to the search query. Abstracts associated with web documents may also be determined based on particular search terms of a search query. After a list of web documents and associated abstracts has been determined, such information may be transmitted to a user's web browser for display.

For example, search engine results 200 may comprise links to several different web documents listed on a page of results. In this example, ten results are shown on a first page of results. As shown, a particular result on a list may include three relevant items—e.g., a title 220, an abstract 225, and a URL 230. A title may be underlined or displayed in bold font or in a different color from other text in the results. As discussed above, an abstract 225 may include a short description of a web document that is extracted from a portion of the web document. Several different abstracts may be associated with a particular web document, and a particular abstract may be included in a search result that is most relevant to a particular search query, for example.

A user may view a web document by selecting either a title 220, abstract 225, or URL 230. Selecting a title 220 or URL 230, for example, may result in a web document being transmitted for viewing in a user's web browser at the start or top of the web document. Selecting an abstract 225, on the other hand, may result in a web document being transmitted for viewing in a user's web browser advanced to a location so that a portion of a web document as designated by an anchor tag is displayed within a predefined location of user's web browser. For example, such a predefined location of a user's web browser or graphical user interface may comprise a top portion of the web browser or graphical user interface.

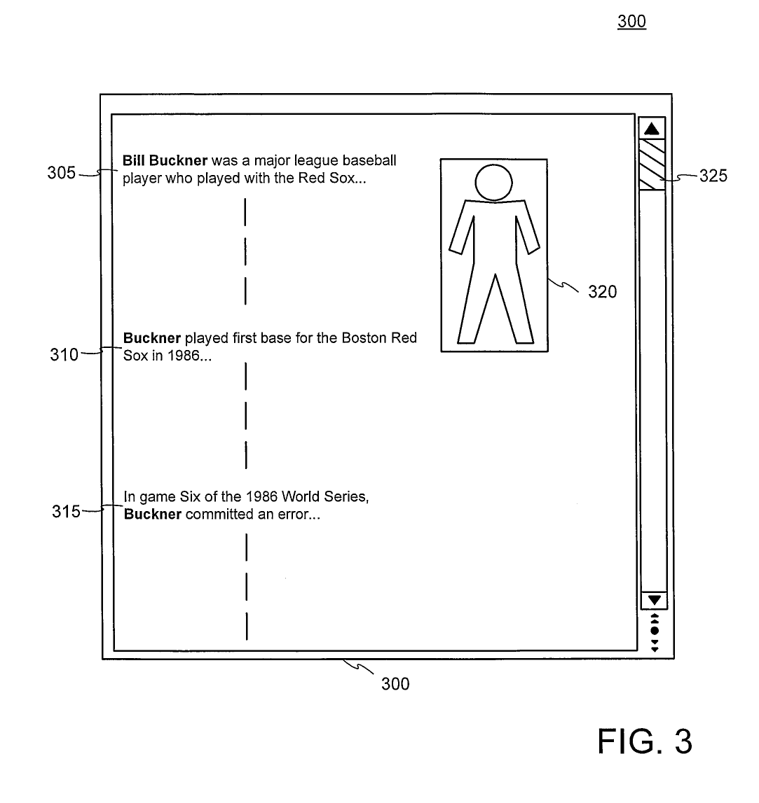

FIG. 3 illustrates a web document 300 according to one or more implementations. As shown, web document 300 may include various portions of text or images. In this example, web document includes three displayed paragraphs 305, 310, and 315 and an image 320. Web document 300 may include one or more tags included by a programmer, for example. Such tags may or may not be visible to a person viewing such a web document 300 in a web browser. In one example, a different tag may be associated with each of paragraphs 305, 310, and 315.

One or more of paragraphs 305, 310, and 315 may include ID tags. For example, ID tags may be utilized by a programmer to specify that the first line of each paragraph is a certain color, font, or format. Such ID tags may be utilized as anchor tags. For example, a first anchor tag may be included right before words “Bill Buckner” in first paragraph 305, a second anchor tag may be included right before words “Bucker played” in second paragraph 310, and a third anchor tag may be included right before words “In game six” in third paragraph 315.

In one or more implementations, an indexer may analyze content of web document 310 to determine different abstracts for search results. For example, a first abstract may be extracted from first paragraph 305, a second abstract may be extracted from second paragraph 310, and a third abstract may be extracted from third paragraph 315. As discussed above, a particular abstract provided for search results for a web document may be determined by a search engine based at least in part on a relevance between the abstract and a particular search query. For example, an abstract extracted or otherwise taken from third paragraph 315 may be selected for use in search results by a search engine. Accordingly, a nearest anchor tag in a web document prior to third paragraph 315 may be associated with an abstract for provided in a list of search results. Accordingly, if a user selects such an abstract, web document 300 may be displayed and advanced based at least in part on a location of a third anchor tag in the web document 300. In this case, a third anchor tag may indicate that a top portion of web document 300 displayed on a user's display screen begins with the start of third paragraph 315. Accordingly, instead of having to manually use a scroll bar 325 to scroll through web document 300 or having to perform a search to locate a relevant portion of web document 300, such a relevant portion may be automatically displayed in response to a user's selection of an abstract.

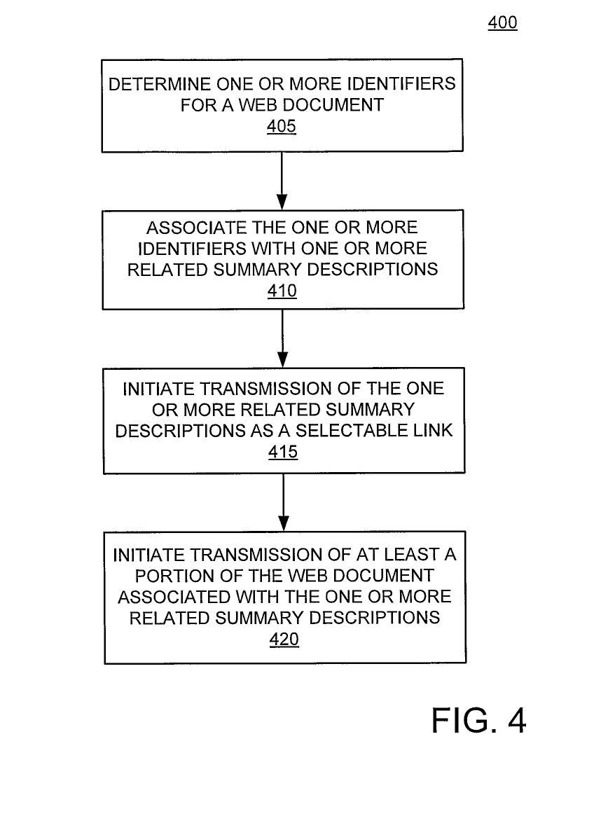

FIG. 4 illustrates a process 400 for providing selectable links to locations in a web document according to one or more implementations. First, at operation 405, one or more identifiers are determined for a web document. Such identifiers may comprise anchor tags that may be determined based on a presence of ID or Name or other tags included in a web document by a programmer, for example. Such a programmer may be a human or computer, in one or more implementations. Next, at operation 410, the one or more identifiers may be associated with one or more related abstract or summary descriptions for the web document. As discussed above, there may be multiple abstracts determined for a particular web document. In one implementation, an abstract may be associated with an identifier, such as an anchor tag so that selecting such an abstract may result in a web document being retrieved and displayed to a user with a relevant portion of such a web document being displayed.

Next, at operation 415, transmission of the one or more related abstract or summary descriptions as a selectable link is initiated. Such information may be displayed in a list of search results for a particular search query in a user's web browser. A user may select an abstract or summary of a web document to retrieve the web document and advance to a portion of the web document associated with the abstract or summary. As discussed above, an amount by which a web document is advanced may be specified via use or one or more identifiers or anchor tags. Finally, at operation 420, transmission of at least a portion of the web document associated with the one or more related summary descriptions for display is initiated in response to receiving a selection of the selectable link.

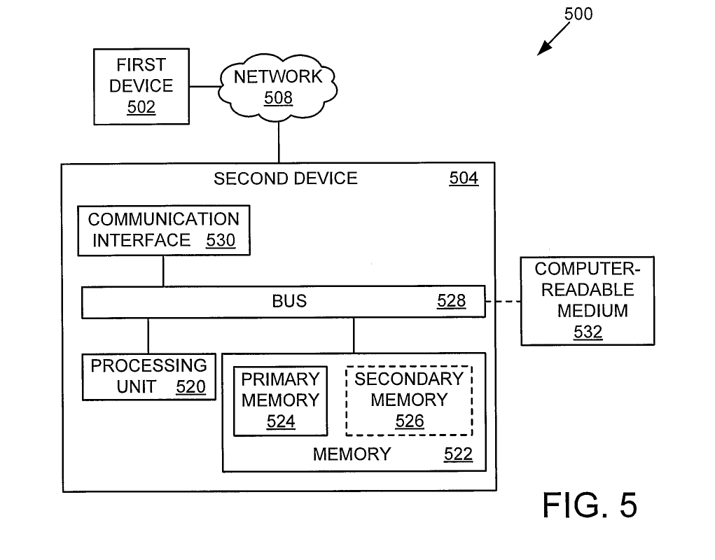

FIG. 5 is a schematic diagram illustrating a computing environment system 500 that may include one or more devices configurable to perform a search using one or more techniques illustrated above, for example, according to one implementation. System 500 may include, for example, a first device 502 and a second device 504, which may be operatively coupled together through a network 508.

First device 502 and second device 504, as shown in FIG. 5, may be representative of any device, appliance or machine that may be configurable to exchange data over network 508. First device 502 may be adapted to receive a user input from a program developer, for example. By way of example but not limitation, either of first device 502 or second device 504 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between first device 502 and second device 504. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 500, and the processes and methods as further described herein, may be implemented using or otherwise include hardware, firmware, software, or any combination thereof.

Thus, by way of example but not limitation, second device 504 may include at least one processing unit 520 that is operatively coupled to a memory 522 through a bus 528.

Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 532. Computer-readable medium 532 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
determining one or more identifiers for an electronic web document;
associating the one or more identifiers with one or more related summary descriptions for the web document;
transmitting the one or more related summary descriptions in an electronic communications network as a link which is selectable within a graphical user interface of a computing platform in response to receiving a search query; and
transmitting the web document in the electronic communications network and advancing the web document to display at least a portion of the web document associated with the one or more summary descriptions in a predefined location in the graphical user interface in response to receiving a selection of the link.

2. The method of claim 1, further comprising crawling the electronic communications network to locate the web document.

3. The method of claim 1, further comprising indexing the web document based at least in part on one or more keywords within content of the web document.

4. The method of claim 3, further comprising determining the one or more related summary descriptions for the web document based at least in part on the one or more key words.

5. The method of claim 1, wherein the web document comprises a video file.

6. The method of claim 1, wherein at least one or the one or more identifiers comprises a user-designated identifier with the web document.

7. The method of claim 1, wherein the predefined location in the graphical user interface comprises a top portion of the graphical user interface.

8. An apparatus comprising:
a communication interface adapted to at least transmit digital signals through an electronic communication network;
a special purpose computing device programmed with instructions to:
determine one or more identifiers for a web document;
associate the one or more identifiers with one or more related summary descriptions for the web document;
initiate transmission, via the communication interface, of the one or more related summary descriptions as a selectable link in response to received a search query; and
initiate transmission, via the communication interface, and advance the web document to display at least a portion of the web document associated with the one or more summary descriptions in a predefined location in the graphical user interface in response to receiving a selection of the link.

9. The apparatus of claim 8, wherein the special purpose computing device is further programmed with instructions to crawl the electronic communications network to locate the web document.

10. The apparatus of claim 8, wherein the special purpose computing device is further programmed with instructions to index the web document based at least in part on one or more keywords within content of the web document.

11. The apparatus of claim 10, wherein the special purpose computing device is further programmed with instructions to determine the one or more related summary descriptions for the web document based at least in part on the one or more key words.

12. The apparatus of claim 8, wherein the web document comprises a video file.

13. The apparatus of claim 8, wherein at least one or the one or more identifiers comprises a user-designated identifier with the web document.

14. The apparatus of claim 8, wherein the predefined location in the graphical user interface comprises a top portion of the graphical user interface.

15. An article comprising: a storage medium having stored thereon instructions executable by a processor to:
determine one or more identifiers for a web document;
associate the one or more identifiers with one or more related summary descriptions for the web document;
initiate transmission of the one or more related summary descriptions in an electronic communications network as a selectable link in response to received a search query; and
initiate transmission, via the electronic communications network, and advance the web document to display at least a portion of the web document associated with the one or more summary descriptions in a predefined location in the graphical user interface in response to receiving a selection of the link.

16. The article of claim 15, wherein the instructions are further executable by the processor to crawl an electronic communications network to locate the web document.

17. The article of claim 15, wherein the instructions are further executable by the processor to index the web document based on one or more keywords within content of the web document.

18. The article of claim 17, wherein the instructions are further executable by the processor to determine the one or more related summary descriptions for the web document based at least in part on the one or more key words.

19. The article of claim 15, wherein the web document comprises a video file.

20. The article of claim 15, wherein at least one or the one or more identifiers comprises a user-designated identifier with the web document.
